(19) United States
(12) Patent Application Publication
(10) Pub. No.: US 2016/0048876 A1
(43) Pub. Date: Feb. 18, 2016

(54) CATEGORIZING GEOGRAPHIC AREAS BASED ON USER INTERACTIONS

(71) Applicant: Google Inc., (US)

(72) Inventors: Bruce W. Murphy, Pyrmont (AU); Nicolas S. Wettstein, Manly (AU)

(73) Assignee: Google Inc., Mountain View, CA (US)

(21) Appl. No.: 13/764,534

(22) Filed: Feb. 11, 2013

(51) Int. Cl. G06Q 30/00; G06F 17/30

(52) U.S. Cl. CPC G06Q 30/0261; G06F 17/30241

(57) ABSTRACT

A system for categorizing geographic areas may include one or more processors and a memory. The one or more processors may receive a plurality of geographic locations each having been associated with one of a plurality of categories based at least in part on a plurality of user interactions. The one or more processors may associate a geographic area that encompasses the plurality of geographic locations with a category of the plurality of categories that has a highest commonality across the plurality of geographic locations. The one or more processors may receive an advertisement request that comprises an indication of one of the plurality of geographic locations that is encompassed by the geographic area, and provide an advertisement that is selected based at least in part on the category of the plurality of categories associated with the geographic area that encompasses the plurality of geographic locations.

### TECHNICAL FIELD

The present description relates generally to categorizing geographic areas, and more particularly, but not exclusively, to categorizing geographic areas based on user interactions.

### BACKGROUND

In online advertising systems, advertisements are presented to users on web pages, such as on a web page that displays a geographical map. If a user clicks on an advertisement on a web page, and/or performs some other action subsequent to clicking on an advertisement, the operator of the web page may be compensated, such as by the entity or business associated with the advertisement. In some instances, the likelihood of a user clicking on an advertisement may be directly linked to the relevance that the advertisement has to the user, such as the relevance of the advertisement to a map being viewed by the user. Thus, it may be desirable for web page operators, such as geographical map providers, to present advertisements to users that have relevance to the users, such as advertisements that are relevant to the maps being viewed by the users, in order to increase the likelihood that the users will click on one of the presented advertisements.

### SUMMARY

The disclosed subject matter relates to a computer implemented method for categorizing geographic areas. The method may include determining, using one or more computing devices, a plurality of geographic locations each associated with one of a plurality of categories. The method may further include determining, using the one or more computing devices, a plurality of geographic areas, each of the plurality of geographic areas encompassing at least one of the plurality of geographic locations. The method may further include storing, using the one or more computing devices and for each of the plurality of geographic areas, an association between a category of the plurality of categories that has a highest commonality across the at least one of the plurality of geographic locations encompassed by each of the plurality of geographic areas, and each of the plurality of geographic areas, respectively.

In another aspect, the computer implemented method may include receiving, using one or more computing devices, a plurality of user interactions with a map service. The method may further include determining, using the one or more computing devices, a plurality of outcomes based on the plurality of user interactions, wherein each of the plurality of outcomes is associated with one of a plurality of geographic locations. The method may further include determining, using the one or more computing devices and for each of the plurality of outcomes, one of a plurality of categories that relates to each of the plurality of outcomes. The method may further include associating, using the one or more computing devices, the one of the plurality of categories that relates to each of the plurality of outcomes with the one of the plurality of geographic locations associated with each of the plurality of outcomes, respectively. The method may further include identifying, using the one or more computing devices, a geographic area that encompasses at least one of the plurality of geographic locations. The method may further include determining, using the one or more computing devices, a category of the plurality of categories having a highest commonality across the at least one of the plurality of geographic locations, and storing, using the one or more computing devices, an association between the category of the plurality of categories having the highest commonality across the at least one of the plurality of geographic locations and the geographic area that encompasses the at least one of the plurality of geographic locations.

The disclosed subject matter also relates to a system for categorizing geographic areas based on user interactions. The system may include one or more processors and a memory including instructions that, when executed by the one or more processors, cause the one or more processors to: receive a plurality of geographic locations each having been associated with one of a plurality of categories based at least in part on a plurality of user interactions with a map service, associate a geographic area that encompasses the plurality of geographic locations with a category of the plurality of categories that has a highest commonality across the plurality of geographic locations, receive an advertisement request that comprises an indication of one of the plurality of geographic locations that is encompassed by the geographic area, and provide an advertisement that is selected based at least in part on the category of the plurality of categories associated with the geographic area that encompasses the one of the plurality of geographic locations.

The disclosed subject matter also relates to a non-transitory machine-readable medium embodying instructions that, when executed by a machine, allow the machine to perform a method for providing advertisements based on categorizations of geographic areas. The method may include determining a plurality of geographic locations associated with a plurality of categories based on a plurality of user interactions. The method may further include determining a plurality of geographic areas, each of the plurality of geographic areas encompassing at least one of the plurality of geographic locations, wherein each of the plurality of geographic locations is encompassed by one of the plurality of geographic areas. The method may further include associating, each of the plurality of geographic areas with the category of the plurality of categories that has a highest commonality across the at least one of the plurality of geographic locations encompassed by each of the plurality of geographic areas, respectively. The method may further include receiving an advertisement request that comprises an indication of a geographic region, and providing an advertisement that is selected based at least in part on the category of the plurality of categories that is associated with the geographic area of the plurality of geographic areas that encompasses the geographic region.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a system for categorizing geographic areas based on user interactions in accordance with one or more implementations.

FIG. 2 illustrates a flow diagram of an example process for categorizing geographic areas based on user interactions in accordance with one or more implementations.

FIG. 3 illustrates a flow diagram of an example process for categorizing geographic areas based on user interactions in accordance with one or more implementations.

FIG. 4 illustrates a flow diagram of an example process for categorizing geographic areas based on user interactions in accordance with one or more implementations.

FIG. 5 illustrates an example user interface for a system for categorizing geographic areas based on user interactions in accordance with one or more implementations.

FIG. 6 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In some instances, structures and components are shown in block diagram form in order to avoid obscuring the concepts of the subject technology.

I. Overview

In the subject system for categorizing geographic areas based on user interactions, geographic areas are categorized based on user interactions that relate to one or more geographic locations that are encompassed by the geographic areas. For example, user interactions with a map service that relate to geographic locations may be analyzed to determine categories that are associated with the geographic locations. The subject system may then determine discrete geographic areas that encompass the geographic locations. Each geographic area may be associated with the category that is the most common across the geographic locations that are encompassed by the geographic area. The geographic areas may be minimized to the smallest sized areas that encompass a certain number of geographic locations that are associated with a common category, e.g. such that the number of geographic locations that are associated with the common category satisfies a threshold. Thus, the geographic areas may be discretely defined, and associated with categories, based on clusters of user intent when interacting with a map service, rather than by geographic boundaries or other geographic markers. Consequently there may be high likelihood that the category that is associated with a given geographic area will be relevant to a user viewing the geographic area. Accordingly, the categorizations of the geographic areas may be used to provide relevant advertisements to a user viewing a web page that displays a map, such as when the user's intent in viewing the web page and/or the map can not otherwise be determined and/or to supplement a determination of a the user's intent.

In one or more implementations, the subject system stores user interaction data that describes user interactions with a map service, e.g. user searches, subsequent interactions, etc. The subject system may periodically analyze the user interaction data to determine outcomes of the user interactions, such as positive outcomes, e.g. successful searches, and negative outcomes, e.g. unsuccessful searches. For example, the subject system may identify a successful search when the user interaction data indicates that a user performed a click-through to a web page of a business and did not return to the map service (e.g., a “long click”), that a user requested driving directions to a business, that a user indicated a positive preference for a business, etc. Conversely, the subject system may identify an unsuccessful search when the user interaction data indicates that a user immediately performed a second search without performing a long click, or without performing any of the other actions that are indicative of a successful search and/or a positive outcome. In one or more implementations, the subject system may weight an outcome, e.g. based on how strongly the outcome reflects a user's intent and/or preference. For example, an outcome of a user requesting driving directions to a business may be weighted higher than an outcome of a user clicking through to web page of a business. In one or more implementations, positive outcomes may be weighted positively, or each positive outcome may be assigned a value of positive one, and the negative outcomes may be weighted negatively, or each negative outcome may be assigned a value of negative one.

The subject system may also determine categories and geographic locations that relate to the outcomes. For example, the category relating to a given outcome may be the category that is associated with a search that preceded the outcome, a category associated with a business for which a user performed an action indicative of a positive outcome, e.g. a long click, or a category associated with any of the user interaction data that led to the outcome. The geographic location that relates to a given outcome may be the geographic location, or geographic region, being displayed by the map service, e.g. in a viewport, when the outcome occurred. For each of the outcomes, the subject system may store an association between the category that relates to the outcome and the geographic location that relates to the outcome. In one or more implementations, the association may be weighted based on the determined weight of the outcome, if any.

After storing the associations between the categories and the geographic locations, the subject system may utilize one or more clustering algorithms to determine clusters of proximal geographic locations that have a common category. Based on the clustering results, the subject system may determine discrete geographic areas that encompass the clusters of geographic locations. The subject system may determine the geographic areas such that the number of geographic locations within a given geographic area that are associated with the common category, e.g. the category having the highest commonality across the geographic locations, satisfies a threshold. If the associations between the geographic locations and the categories are weighted, the subject system may determine the category having the highest weighted commonality across the geographic locations. For example, the weights of the associations of geographic locations with a given category may be summed together to determine the weighted commonality of the given category.

If, for a given geographic area, the number of geographic locations within the geographic area that are associated with the category having the highest commonality does not satisfy the threshold, the subject system may increase the size of geographic area to include a larger number of geographic locations. Conversely, for a given geographic area, if the number of geographic locations within the geographic area that are associated with the category having the highest commonality does satisfy the threshold, the subject system may reduce the size of the geographic area to include the smallest number of the geographic locations that satisfies the threshold. In this manner, the size of the geographic areas may be minimized to the smallest sized geographic areas that satisfies the threshold. The subject system may then store associations between the geographic areas and the categories in a memory.

In one or more implementations, the subject system may periodically associate the geographic areas with categories in an offline mode and may then provide the associations between the geographic areas and categories to an online system, such as an online advertisement serving system. The online advertisement serving system may utilize the associations to provide relevant advertisements to users viewing web pages, such as web pages that display a map, e.g. without a search query, search results, and/or other indicators of user intent. For example, a user may be viewing a web page that displays instructions to an establishment, such as a hotel, and the web page may include a small map that displays the location of the hotel. The online advertisement serving system may receive a request for an advertisement to display on the web page. The request may include an indication of the geographic location, or geographic region, that is displayed on the map. The online advertisement serving system may determine the geographic area that encompasses, or overlaps the geographic location, or geographic region, that is displayed on the map. The online advertisement serving system may then select an advertisement based at least in part on the category that is associated with the determined geographic area, as indicated by the associations between the geographic areas and categories received from the offline system, and may provide the advertisement for display on the web page. Thus, the user may be presented with an advertisement that is relevant to the map being displayed, as indicated by prior user interactions with the map service, and consequently the advertisement may also be relevant to the user.

In one or more implementations, the subject system may generate separate categorizations of geographic areas for separate groups of users. In one or more implementations, a set of categorizations of geographic areas for a given group of users may be referred to as a geographic area categorization model for the group of users. For example, the subject system may create separate groups of users based on one or more user characteristics or user profiles, such as user demographic data, user location, etc. The subject system may then filter the user interaction data based on the characteristics of the users associated with the user interaction data when determining the associations between the geographic areas and the categories. Accordingly, the subject system may generate different categorizations of a given geographic area for different groups of users. The online advertisement system may receive the categorizations of the geographic areas for each group of users. The online advertisement system may then determine which categorizations to use for providing an advertisement to a given user based on which of the groups of users the given user belongs to.

In situations in which the systems discussed herein store and/or analyze information about users, or may make use of information about users, the users may be provided with an opportunity to control whether programs or features collect user information (e.g., information about a user's social network, social actions or activities, profession, a user's preferences, or a user's current location), or to control whether and/or how to receive content, e.g. advertisements, that may be more relevant to the user. In addition, certain data may be processed and/or filtered in one or more ways before it is stored or used, such that any personally identifiable information is removed. For example, information pertaining to a user's identity may be processed and/or filtered such that no personally identifiable information can be determined from the processed information, or information pertaining to a user's geographic location may be generalized when location information is obtained (such as to a city, ZIP code, or state level), such that a particular location of a user cannot be determined. Thus, the user may have control over how information is collected about the user and how information about the user is used by the systems discussed herein.

II. Example Network Environments for a System for Categorizing Geographic Areas Based on User Interactions

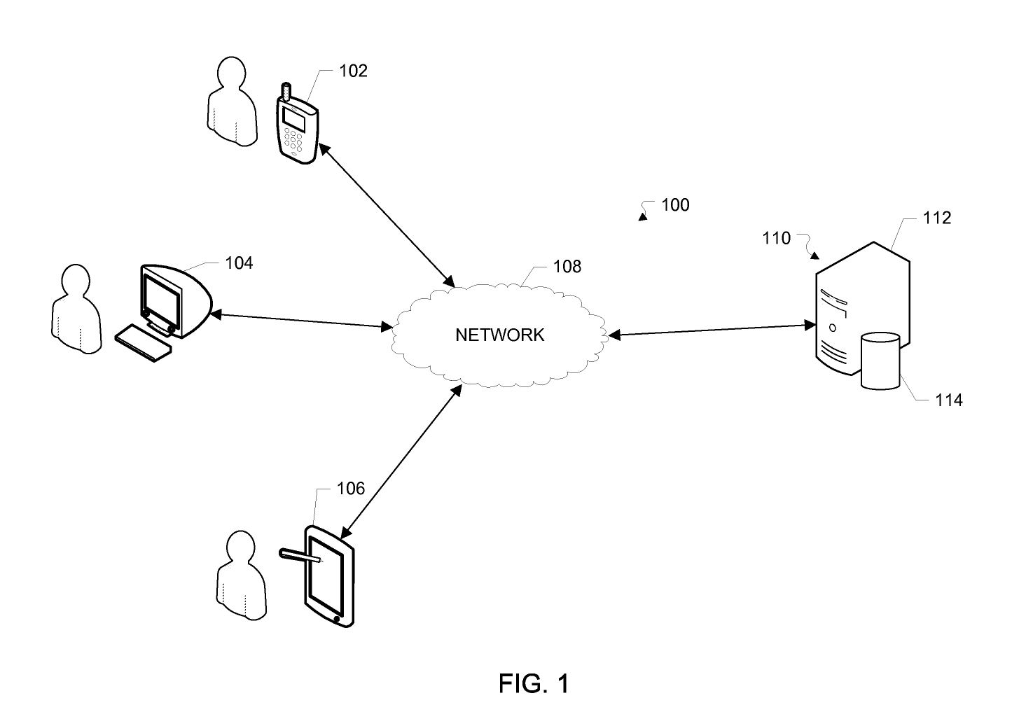

FIG. 1 illustrates an example network environment 100 which may implement a system for categorizing geographic areas based on user interactions in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The network environment 100 may include a number of electronic devices 102, 104, 106 communicably connected to a server 110, such as by the network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

In some example embodiments, the electronic devices 102, 104 and 106 can be computing devices such as laptop or desktop computers, smartphones, personal digital assistants (“PDAs”), portable media players, tablet computers, televisions or other displays with one or more processors coupled thereto and/or embedded therein, or other appropriate computing devices that can be used to for displaying a web page or web application, such as a web page or a web application that includes a geographic map. In the example of FIG. 1, the electronic device 102 is depicted as a smartphone, the electronic device 104 is depicted as a desktop computer, and the electronic device 106 is depicted as a tablet device.

In one example, server 110 may be a single computing device such as a computer server. In another example, server 110 may represent one or more computing devices (such as a cloud of computers and/or a distributed system) that are communicatively coupled, such as communicatively coupled over the network 108, that collectively, or individually, perform one or more functions that can be performed server-side, such as search result retrieval, advertising content retrieval, advertising content serving, and/or generally any functions that can be performed server-side. The one or more computing devices of the server 110 may be geographically collocated and/or the one or more computing devices of the server 110 may be disparately located. The server 110 may be coupled with various databases, storage services, or other computing devices. The server 110, and the coupled databases, storage services, or other computing devices may be geographically collocated, or may be disparately located.

In one or more implementations, the server 110 includes a processing device 112 and a data store 114. The processing device 112 executes computer instructions stored in the data store 114, for example, to categorize geographic areas based on user interactions. In one or more implementations, the data store 114 may store the computer instructions on non-transitory computer-readable medium.

The server 110 may host a web server that is communicatively coupled to client devices, such as web browsers of client devices (e.g., electronic devices 102, 104 or 106) via network 108. In one example, the subject system may be integrated into one or more of a search engine, a map engine, an advertising content retrieval system and/or an advertising content serving system hosted at server 110. In another example, the subject system may be hosted at server 110 and may be communicatively coupled to one or more remote servers hosting one or more other search engines, map engines, advertising content retrieval systems and/or advertising content serving systems (e.g., one or more remote servers) over one or more networks (e.g., network 108).

In operation, the server 110 may provide a geographic map to one of the electronic devices 102, 104, 106, such as the electronic device 102, for display to a user. A user may view the map on the electronic device 102 and the user may input a query to the electronic device 102, such as in order to receive additional information on the map. The electronic device 102 may communicate the query to the server 110, such as over the network 108. In response to the query, the server 110 may provide one or more objects, such as advertising content items and non-advertising content items, to the electronic device 102 for display on the map to the user. The one or more objects may be associated with businesses that are related to the query.

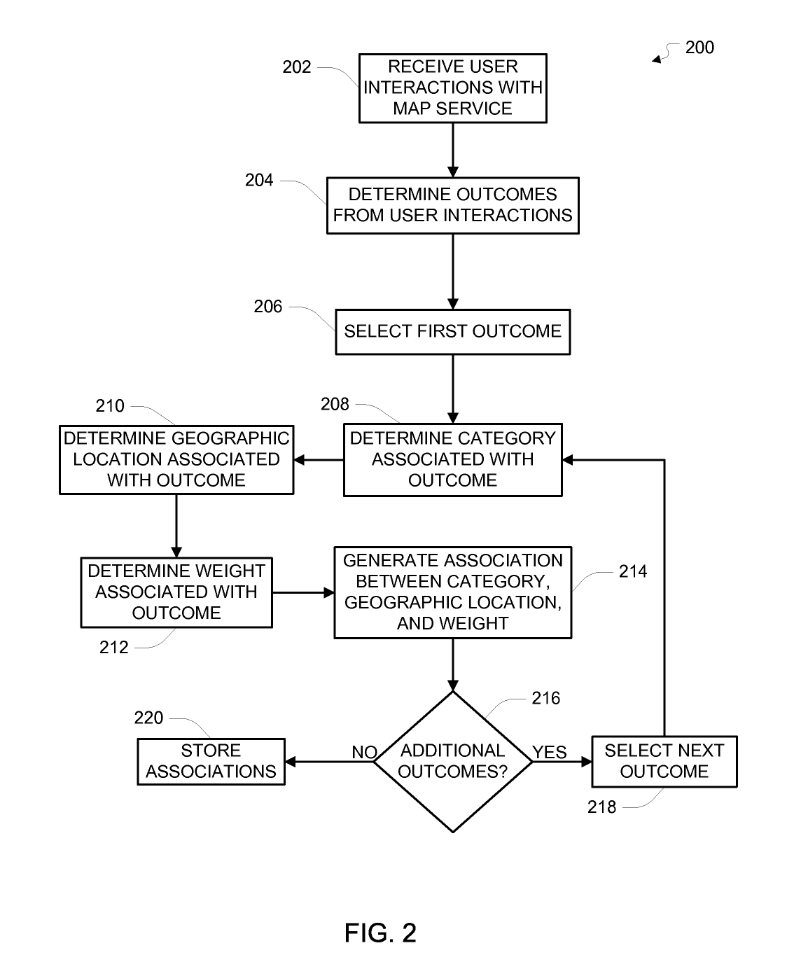

The user may select one of the objects on the map, such as to click though to a web page associated with the object, to receive additional information regarding the business associated with the object, e.g. driving directions, etc. The server 110 may store data corresponding to the interactions of the user with the map, such as in the data store 114. The user interaction data may include an indication of a geographic location, and/or a geographic region, being displayed by the map, e.g. in a viewport, at the time of each user interaction. The server 110, and/or another computing device, may analyze the user interaction data to determine outcomes of the user interactions, e.g. positive and negative outcomes. In one example, a positive outcome may be determined when the user interaction data indicates that the user clicked on a link to an external web site and did not return to the map page, e.g. a long click. In one or more implementations, a negative outcome may be determined when the user interaction data indicates that the user performed a second search without interacting with the results of a first search. The outcomes may each be associated with a geographic location and/or a geographic area, such as the geographic location and/or area that was being displayed to the user at the time that the outcome occurred. The server 110 may also determine categories associated with the outcomes, such as a category of a search that led to the outcome. The server 110 may then store an association between the geographic location associated with each outcome and the category associated with each outcome, in order to associate geographic locations with categories. An example process of associating geographic locations with categories based on user interaction data is discussed further below with respect to FIG. 2.

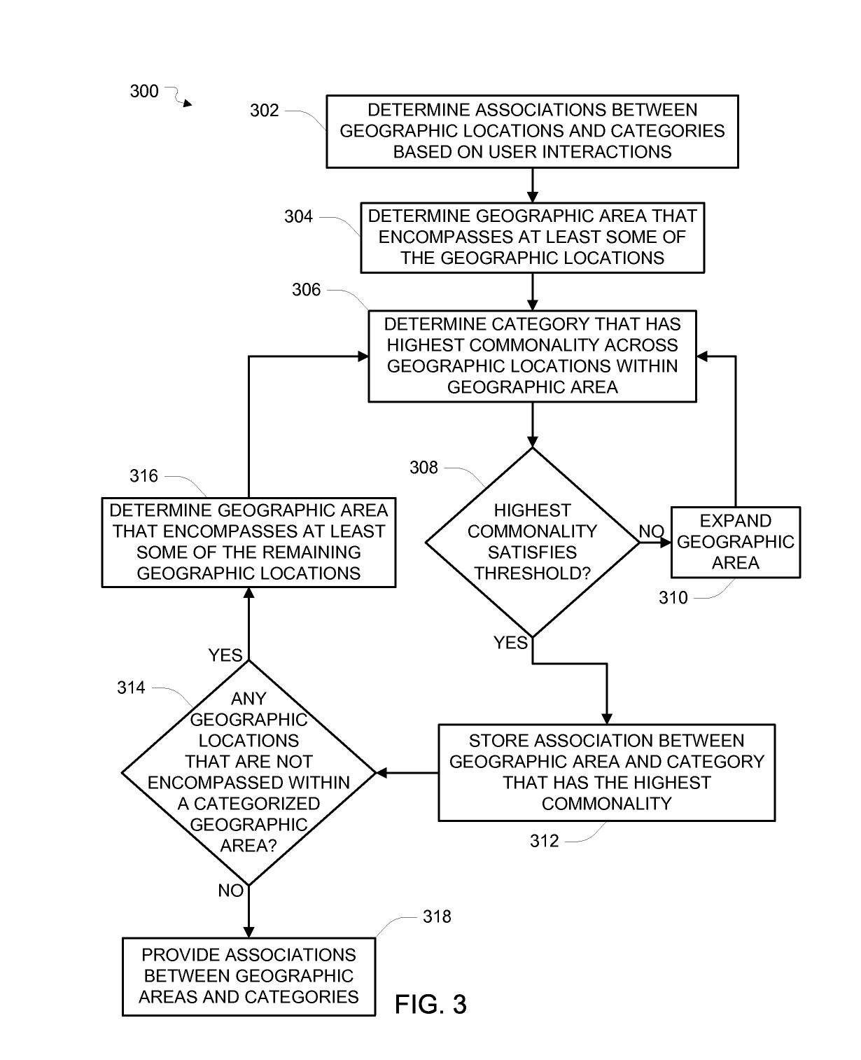

The server 110 may then process the associations between the geographic locations and categories, such as by using a clustering algorithm to determine clusters of proximal geographic locations that share a common category. The server 110 may then determine geographic areas that encompass a threshold number of geographic locations that are each associated with a common category, and the server 110 may associate each geographic area with the common category of the encompassed geographic locations. The server 110 may maintain and/or update the categories that are associated with the geographic areas in real-time, e.g. as additional user interaction data is received. Alternatively, or in addition, the server 110 may periodically update the categories that are associated with the geographic areas, e.g. in an offline mode. An example process for associating geographic areas with categories based on user interaction data is discussed further below with respect to FIG. 3.

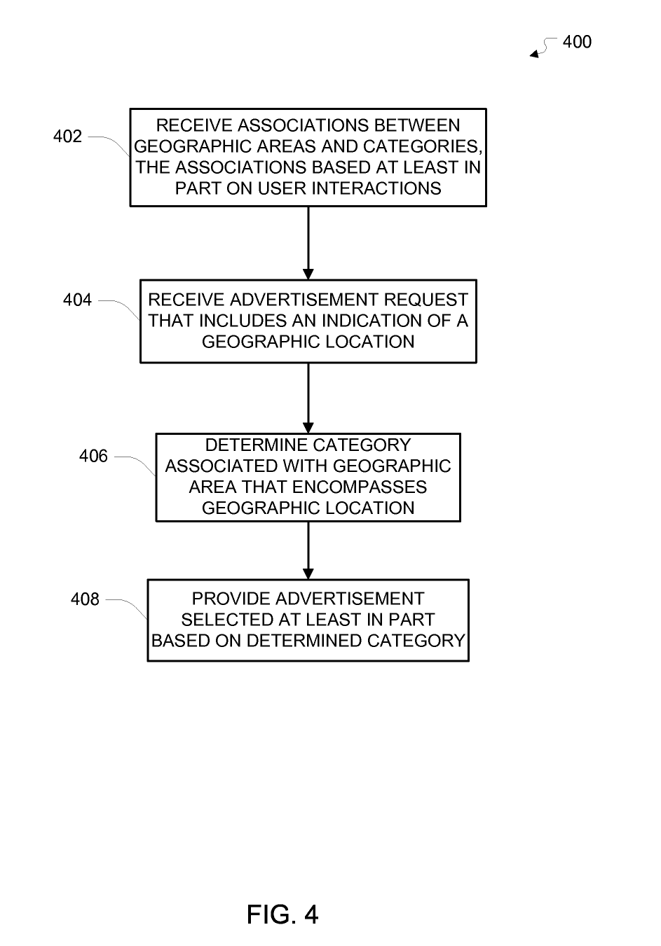

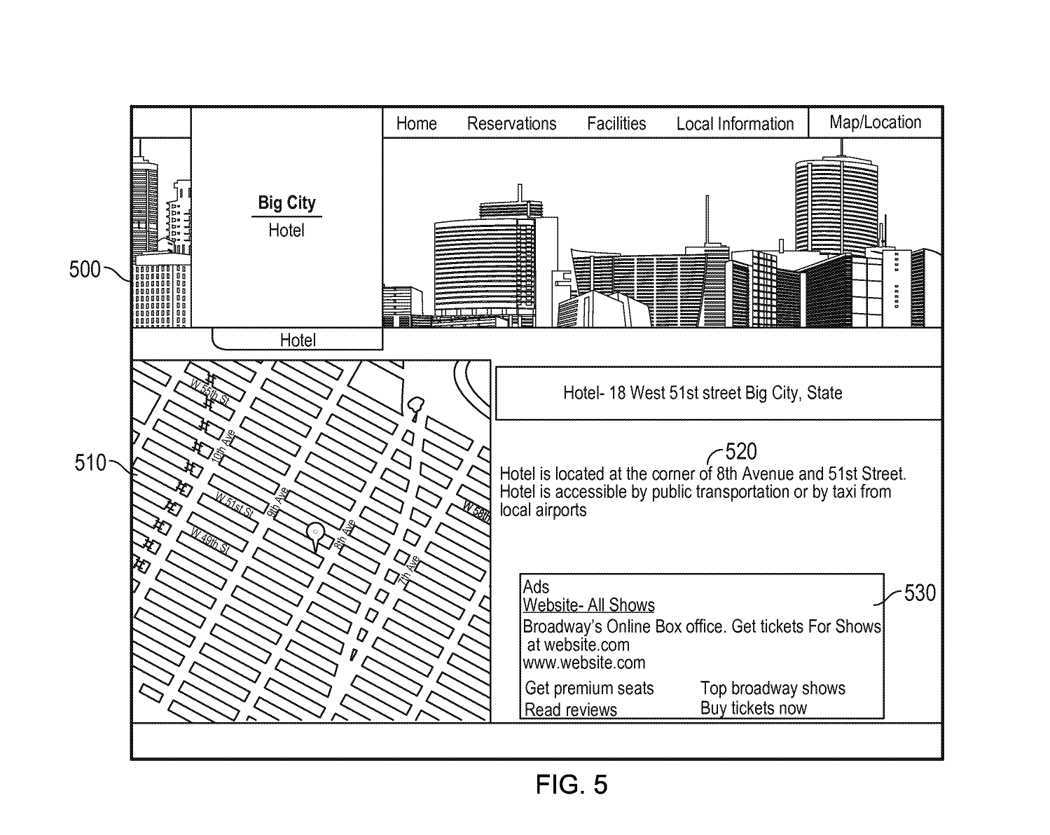

The server 110 may then utilize the categories associated with the geographic areas to provide relevant information, such as advertisements, to a user viewing a map that displays a given geographic area, e.g. when the intent of the user in viewing the map can not otherwise be determined, and/or to supplement a determination of the user's intent in viewing the map. Alternatively, or in addition, the server 110 may provide the associations to another computing device, such as an advertisement serving system, that may use the associations to provide relevant information, such as advertisements, to users viewing a geographic map or other geographically associated data and/or any data from which a geographic location or a geographic region is determinable. An example process for providing relevant information, such as advertisements, based on the categories associated with the geographic areas is discussed further below with respect to FIG. 4. An example user interface displaying advertisements selected based at least in part on categories that are associated with geographic areas is discussed further below with respect to FIG. 5.

III. Example Processes for Categorizing Geographic Areas Based on User Interactions

FIG. 2 illustrates a flow diagram of example process 200 for categorizing geographic areas based on user interactions in accordance with one or more implementations. For explanatory purposes, example process 200 is described herein with reference to example network environment 100 of FIG. 1; however, example process 200 is not limited to example network environment 100 of FIG. 1. Further for explanatory purposes, the blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In block 202, the server 110 receives user interaction data that pertains to user interactions with a map service. In one or more implementations, the server 110 may provide the map service, may receive the user interaction data from users interacting with the map service, and may store the user interaction data, e.g. in the data store 114. Alternatively, or in addition, the server 110 may receive the user interaction data from another system and/or another server, e.g. a system and/or server that is providing a map service. The user interaction data may include data that describes a user's interaction with the map service, such as any searches performed by the user, any search results that were interacted with by the user, e.g. links that were clicked on by the user, driving directions that were requested by the user, any movement of the map that was initiated by the user, e.g. panning, scrolling, zooming, etc., and/or generally any interaction that a user may have with a map service.

In one or more implementations, any user interaction that is described by the user interaction data may be associated with an identifier of a geographic area, or a geographic location, such as a geographic area and/or geographic location that was displayed on the map at the time that the user interaction occurred. In one or more implementations, any user interaction that is described by the user interaction data may also be associated with a timestamp that indicates the date and/or time that the user interaction occurred.

In block 204, the server 110 determines outcomes from the user interaction data. In one or more implementations, the outcomes may be characterized as positive outcomes or negative outcomes. In one or more implementations, the server 110 may identify a positive outcome any time the user interaction data indicates that a user performed a search, or was otherwise searching for a thing and/or place, and the user found the thing and/or place that they were searching for, and/or that the user found a thing and/or a place that interests them. For example, the server 110 may determine a positive outcome when the user interaction data indicates that the user clicked on a link to an external web site and the user did not return to the map service, e.g. a long click. In one or more implementations, the server 110 may identify a negative outcome any time the user interaction data indicates that a user performed a search, or was otherwise searching for a thing and/or a place, and the user did not find the thing and/or place that they were searching for and/or the user did not find any thing and/or place of interest. For example, the server 110 may determine a negative outcome when the user interaction data indicates that the user performed a second search without interacting with the results of a first search.

In block 206, the server 110 selects the first outcome determined in block 204. In block 208, the server 110 determines a category that is associated with the selected outcome. For example, the server 110 may determine the category associated with the selected outcome as a category that is associated with a search term that directly or indirectly resulted in the selected outcome, a category that is associated with a business or place corresponding to the selected outcome, or generally any category that is associated with any user interaction that directly, or indirectly, resulted in the selected outcome, and/or any category that is associated with a place, business, etc. that corresponds to the selected outcome.

In block 210, the server 110 determines a geographic location that is associated with the selected outcome. For example, the server 110 may determine the geographic location associated with the selected outcome as a geographic location and/or a geographic area that was displayed on the map at the time that the outcome occurred. Alternatively, or in addition, the server 110 may determine the geographic location associated with the selected outcome as a geographic location of the place, business, etc. that corresponds to the selected outcome, e.g. the place, business, etc. associated with a website that the user clicked through to. In one or more implementations, the geographic location may be defined by a set of geographic coordinates, such as latitude and longitude coordinates. Alternatively, or in addition, the geographic location may be defined by an object generated by a geographical indexing system, such as a system that segments geographic areas into cells.

In block 212, the server 110 determines a weight that is associated with the selected outcome. The weight may be indicative of a level and/or strength of user intent, user preference, and/or user satisfaction that is determinable from the selected outcome. For example, a high level of user satisfaction with an outcome may be determinable from an outcome that corresponds to a user requesting driving directions to a place of business, while a lower level of user satisfaction may be determinable from an outcome that corresponds to a user performing a second search without interacting with the results of the initial search. In one or more implementations, the weight may be indicative of how adequately the outcome satisfied the user's initial intent in accessing the map service, e.g. the user's initial search.

In one or more implementations, negative outcomes, such as outcomes determined from a user performing multiple searches without interacting with the map service, may be weighted lower than positive outcomes, such as a user clicking through to an external website. Alternatively, or in addition, a weight determined for a positive outcome may have a positive value, while a weight associated with a negative outcome may have a negative value. In this manner, the absolute value of the weight may reflect the level and/or strength of user intent, user preference, and/or user satisfaction that is determinable from the outcome, while the sign of the weight may reflect whether the outcome was a positive outcome or a negative outcome. Thus, a negative outcome can have the same level and/or strength of user intent, user preference, and/or user satisfaction as a positive outcome.

In block 214, the server 110 generates an association between the category determined for the selected outcome in block 208, the geographic location determined for the selected outcome in block 210, and the weight determined for the selected outcome in block 212. In one or more implementations, each geographic location may only be associated with a single category and a single weight. Alternatively, or in addition, each geographic location may be associated with multiple categories and/or multiple weights. For example, the user interaction data may indicate that there are multiple outcomes that are associated with a given geographic location and one or more of the outcomes may be associated with a different weight and/or a different category. Alternatively, or in addition, if the user interaction data indicates that a given geographic location is associated with the same category, but different weights, the server 110 may continuously aggregate the weights for the given geographic location and category as they are determined. Thus, in this instance the server 110 may only store a single association between the geographic location and the category, and the server 110 may continuously update the associated weight, e.g. as additional weights are determined for the geographic location and category.

In block 216, the server 110 determines whether there are any additional outcomes that were determined in block 204. If, in block 216, the server 110 determines that there are additional outcomes, the server 110 moves to block 218. In block 218, the server 110 selects the next outcome from the determined outcomes and repeats blocks 208-214 for the next outcome. If, in block 216, the server 110 determines that there are no additional outcomes from the outcomes determined in block 204, the server 110 moves to block 220. In block 220, the server 110 stores the associations generated at block 214. In one or more implementations, the server 110 may store an association at the time that it is generated, e.g. in block 214, rather than storing multiple associations in block 220.

In one or more implementations, blocks 208-214 may occur at the time that any outcome is determined from the user interaction data, rather than after determining multiple outcomes from the user interaction data.

FIG. 3 illustrates a flow diagram of example process 300 for categorizing geographic areas based on user interactions in accordance with one or more implementations. For explanatory purposes, example process 300 is described herein with reference to example network environment 100 of FIG. 1; however, example process 300 is not limited to example network environment 100 of FIG. 1. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In block 302, the server 110 determines associations between geographic locations and categories based on user interactions, e.g. as indicated by user interaction data. For example, the server 110 may perform one or more of the blocks of FIG. 2 to determine associations between geographic locations and categories based on user interaction data. In one or more implementations, the server 110 may retrieve the associations, e.g. from the data store 114, or the server 110 may receive the associations, e.g. from another server or system. In one or more implementations, the associations may be weighted, e.g. as discussed above with respect to FIG. 2.

In block 304, the server 110 determines a geographic area that encompasses at least some, and/or at least one, of the geographic locations. For example, the server 110 may determine the smallest geographic area that encompasses at least a threshold number of the geographic locations, such as one or ten geographic locations. In block 306, the server 110 determines the category that has the highest commonality across the geographic locations of the determined geographic area, e.g. the category that is associated with the largest number of the geographic locations of the determined geographic area. If the associations are weighted, the server 110 may determine the category that has the highest weighted commonality across the geographic locations, e.g. the server 110 may aggregate the weights (positive and/or negative) across the geographic locations for a common category to determine the amount of the weighted commonality of the category.

In block 308, the server 110 determines whether the amount of the highest commonality, or the amount of the highest weighted commonality, satisfies a threshold. In one or more implementations, the threshold may be set to verify that the commonality (or weighted commonality) of the category is sufficiently large enough to be indicative of user intent for the geographic area, e.g. to verify that the category should be associated with the geographic area. In one or more implementations, the threshold that is used in block 308 may also be used when determining a geographic area in block 304, e.g. to ensure that there are enough geographic locations within the geographic area to mathematically satisfy the threshold in block 308, e.g. if all of the geographic locations were associated with the same category.

If, in block 308, the server 110 determines that the amount of the highest commonality (or the amount of the highest weighted commonality) does not satisfy the threshold, the server 110 moves to block 310. In block 310, the server 110 expands the geographic area to include additional geographic locations. The server 110 then repeats blocks 306 and 308 with the expanded geographic area. If, in block 308, the server 110 determines that the amount of the highest commonality, or the amount of the highest weighted commonality, satisfies the threshold, the server 110 moves to block 312. In block 312, the server 110 stores an association between the geographic area and the category determined in block 306, e.g. the category having the highest commonality and/or the highest weighted commonality.

In block 314, the server 110 determines whether there are any remaining geographic locations associated with categories that are not encompassed within a categorized geographic area. If, in block 314, the server 110 determines that there are remaining geographic locations associated with categories that are not encompassed within a categorized geographic area, the server 110 moves to block 316. In block 316, the server 110 determines a geographic area that encompasses at least some of the remaining geographic locations, e.g. the smallest geographic area that encompasses at least a threshold number of the geographic locations. If, in block 314, the server 110 determines that all of the geographic locations associated with categories, e.g. as determined in block 302, are encompassed within a categorized geographic area, e.g. a geographic area associated with a category in block 312, the server 110 moves to block 318. In block 318, the server 110 provides the associations between the geographic areas and the categories, e.g. to an advertisement serving system.

FIG. 4 illustrates a flow diagram of example process 400 for categorizing geographic areas based on user interactions in accordance with one or more implementations. For explanatory purposes, example process 400 is described herein with reference to example network environment 100 of FIG. 1; however, example process 400 is not limited to example network environment 100 of FIG. 1. Further for explanatory purposes, the blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed.

In block 402, the server 110 receives associations between geographic areas and categories where the associations are based at least in part on user interactions. For example, the server 110 may receive from another server, and/or may retrieve from a memory, such as data store 114, the associations between the geographic areas and categories, such as the associations discussed above with respect to FIG. 3. Alternatively, or in addition, the server 110 may generate the associations between the geographic areas and the categories, such as based at least in part on the blocks discussed above with respect to FIG. 3.

In block 404, the server 110 receives an advertisement request that includes an indication of a geographic location. For example, a user interacting with the electronic device 102 may be viewing a web page that includes a map, and the electronic device 102 may transmit an advertisement request to the server 110 that includes an indication of a geographic location and/or a geographic area that is displayed on the map being viewed by the user. In block 406, the server 110 determines a category that is associated with the geographic area that encompasses at least a portion of the geographic location. For example, the server 110 may determine the geographic area that encompasses at least a portion of the geographic location, and the server 110 may retrieve the category that is associated with the geographic area. In one or more implementations, if multiple geographic areas encompass at least a portion of the geographic location, the server 110 may determine the category that is associated with the geographic area that encompasses the largest portion of the geographic location. Alternatively, or in addition, the server 110 may analyze additional information items in the advertisement request, such as a search term, to determine which of the multiple geographic areas that encompass at least a portion of the geographic location to select the category from.

In block 408, the server 110 provides an advertisement that is selected based at least in part on the determined category. For example, the server 110 may use the determined category and/or any other information included in the advertisement request or determinable from the advertisement request, to select an advertisement that may be relevant to the user. The server 110 then provides the advertisement to the electronic device 102 for display on the web page being viewed by the user. An example user interface displaying a map and an advertisement is shown in FIG. 5.

IV. Example User Interfaces for Systems for Categorizing Geographic Areas Based on User Interactions

FIG. 5 illustrates an example user interface 500 for a system for categorizing geographic areas based on user interactions in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The user interface 500 includes a map 510, page content 520 and one or more advertisements 530. In operation, the server 110 may provide the user interface 500 to the electronic device 102 for display to the user. The server 110 may select one or more advertisements 530 to display to the user based at least in part on the category that is associated with the geographic area that will be displayed on the map 510. Alternatively, or in addition, the server 110 may select one or more advertisements 530 to display to the user based at least in part on the category that is associated with the geographic area and/or the page content 520.

In one or more implementations, the user interface 500 may be provided to the electronic device 102 by a third party server. In these one or more implementations, the third party server may transmit an advertisement request to the server 110 that includes an indication of the geographic area that will be displayed on the map 510, and/or an indication of a geographic location that will be displayed on the map 510. The server 110 may determine a category that is associated with the geographic area, and the server 110 may select one or more advertisements 530 based at least in part on the determined category. The server 110 may transmit the one or more advertisements 530 to the third party server. The third party server may add the advertisements 530 to the user interface 500 and may provide the user interface 500 to the electronic device 102 for display to the user.

In one or more implementations, the electronic device 102 may receive the user interface 500 from a server, such as a third party server. Upon rendering the web page for display to the user, but before displaying the web page to the user, the electronic device 102 may transmit an advertisement request to the server 110. The advertisement request may include an indication of the geographic location and/or the geographic region that will be displayed on the map 510. The server 110 may receive the request and may select one or more advertisements 530 for display to the user based at least in part on a category that is associated with the geographic location. The server 110 may provide one or more selected advertisements 530 to the electronic device 102. The electronic device 102 may add the one or more advertisements 530 to the user interface 500 prior to displaying the user interface 500 to the user.

V. Example Systems for Categorizing Geographic Areas Based on User Interactions

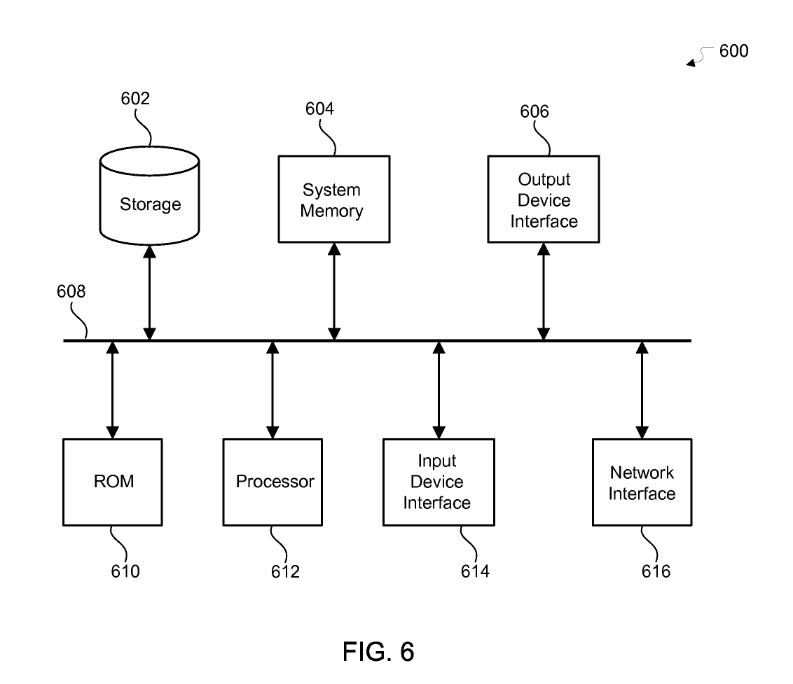

FIG. 6 conceptually illustrates electronic system 600 with which any implementations of the subject technology may be implemented. Electronic system 600, for example, can be a desktop computer, a laptop computer, a tablet computer, a server, a switch, a router, a base station, a receiver, a phone, a personal digital assistant (PDA), or generally any electronic device that transmits signals over a network. Such an electronic system includes various types of computer readable media and interfaces for various other types of computer readable media. Electronic system 600 includes bus 608, processing unit(s) 612, system memory 604, read-only memory (ROM) 610, permanent storage device 602, input device interface 614, output device interface 606, and network interface 616, or subsets and variations thereof.

Bus 608 collectively represents all system, peripheral, and chipset buses that communicatively connect the numerous internal devices of electronic system 600. In one or more implementations, bus 608 communicatively connects processing unit(s) 612 with ROM 610, system memory 604, and permanent storage device 602. From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. One or more implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores any of the instructions and data that processing unit(s) 612 needs at runtime. In one or more implementations, the processes of the subject disclosure are stored in system memory 604, permanent storage device 602, and/or ROM 610. From these various memory units, processing unit(s) 612 retrieves instructions to execute and data to process in order to execute the processes of one or more implementations.

Bus 608 also connects to input and output device interfaces 614 and 606. Input device interface 614 enables a user to communicate information and select commands to the electronic system. Input devices used with input device interface 614 include, for example, alphanumeric keyboards and pointing devices (also called “cursor control devices”). Output device interface 606 enables, for example, the display of images generated by electronic system 600. Output devices used with output device interface 606 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, bus 608 also couples electronic system 600 to a network (not shown) through network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method for categorizing geographic areas, the method comprising:
determining, using one or more computing devices, a plurality of geographic locations each associated with one of a plurality of categories;
determining, using the one or more computing devices, a plurality of geographic areas, each of the plurality of geographic areas encompassing at least two of the plurality of geographic locations, wherein the plurality of geographic areas are discrete;
receiving, using the one or more computing devices, a plurality of user interactions with a map service;
determining, using the one or more computing devices, a plurality of positive and negative outcomes based on the plurality of user interactions, wherein the positive outcomes are associated with successful searches and the negative outcomes are associated with unsuccessful searches, and wherein each of the plurality of outcomes is associated with one of the plurality of geographic locations;
determining, using the one or more computing devices, a plurality of weights of the plurality of outcomes, wherein the plurality of weights indicate how strongly the plurality of outcomes are indicative of user intent;
determining, using the one or more computing devices and with respect to each of the plurality of outcomes, one of a plurality of categories that relates to each of the plurality of outcomes;
storing, using the one or more computing devices and with respect to each of the plurality of geographic areas, an association between a category of the plurality of categories that is associated with a largest number of the at least two of the plurality of geographic locations encompassed by each of the plurality of geographic areas, and each of the plurality of geographic areas, respectively; determining, using the one or more computing devices, clusters of proximal geographic locations that have a common category, wherein the determining clusters is based at least in part on the stored associations between each geographic area and its corresponding category; and
providing, using the one or more computing devices, an advertisement that is selected based at least in part on the clusters of proximal geographic locations that are determined by the stored associations between the category of the plurality of categories and each of the plurality of geographic areas.

2. The method of claim 1, wherein the determining, using the one or more computing devices, the plurality of geographic locations each associated with one of the plurality of categories, further comprises:
associating, using the one or more computing devices and with respect to each of the plurality of outcomes, the geographic location associated with each of the plurality of outcomes and the category of the plurality of categories that relates to each of the plurality of outcomes.

3. The method of claim 2, wherein the determining, using the one or more computing devices and with respect to each of the plurality of outcomes, the category of the plurality of categories that relates to each of the plurality of outcomes further comprises determining, with respect to at least one of the plurality of outcomes, the category of the plurality of categories that relates to the at least one of the plurality of outcomes based at least in part on a category that is associated with a search for a term that was performed prior to the outcome.

4. The method of claim 2, wherein the determining, using the one or more computing devices and with respect to each of the plurality of outcomes, the category of the plurality of categories that relates to each of the plurality of outcomes further comprises determining, with respect to at least one of the plurality of outcomes, the category of the plurality of categories that relates to the at least one of the plurality of outcomes based at least in part a category associated with a business that is related to the at least one of the plurality of outcomes.

5. The method of claim 2, wherein at least one of the plurality of outcomes comprises at least one of a click-through, a successful search, an indication of a user preference, or an additional information request.

6. The method of claim 2, further comprising:
receiving, using the one or more computing devices, an advertisement request that comprises an indication of a geographic region;
determining, using the one or more computing devices and based on the stored associations, the category of the plurality of categories that is associated with the geographic area of the plurality of geographic areas that encompasses at least a portion of the geographic region; and
providing, using the one or more computing devices, an advertisement that is selected based at least in part on the determined category of the plurality of categories.

7. The method of claim 6, further comprising:
displaying, using the one or more computing devices, the advertisement on a web page that comprises a map, wherein the advertisement is displayed non-overlapping with the map.

8. The method of claim 1, wherein each of the plurality of geographic areas is associated with one of the plurality of categories.

9. A computer-implemented method for categorizing geographic areas based on user interactions, the method comprising:
receiving, using one or more computing devices, a plurality of user interactions with a map service;
determining, using the one or more computing devices, a plurality of positive and negative outcomes based on the plurality of user interactions, wherein the positive outcomes are associated with successful searches and the negative outcomes are associated with unsuccessful searches, and wherein each of the plurality of outcomes is associated with one of a plurality of geographic locations;
determining, using the one or more computing devices and with respect to each of the plurality of outcomes, one of a plurality of categories that relates to each of the plurality of outcomes;
associating, using the one or more computing devices, the one of the plurality of categories that relates to each of the plurality of outcomes with the one of the plurality of geographic locations associated with each of the plurality of outcomes, respectively;
determining, using the one or more computing devices, a plurality of weights of the plurality of outcomes, wherein the plurality of weights indicate how strongly the plurality of outcomes are indicative of user intent;
associating, using the one or more computing devices, the category of the plurality of categories that relates to each of the plurality of outcomes with the weight of each of the plurality of outcomes;
identifying, using the one or more computing devices, a geographic area that encompasses at least one of the plurality of geographic locations;
determining, using the one or more computing devices, a category of the plurality of categories associated with a largest number of the at least one of the plurality of geographic locations relative to numbers of the at least one of the plurality of geographic locations associated with other categories of the plurality of categories;
storing, using the one or more computing devices, an association between the geographic area and the category of the plurality of categories associated with the largest number of the at least one of the plurality of geographic locations encompassed by the geographic area;
determining, using the one or more computing devices, clusters of proximal geographic locations that have a common category, wherein the determining clusters is based at least in part on the stored associations between each geographic area and its corresponding category; and
providing, using the one or more computing devices, an advertisement that is selected based at least in part on the clusters of proximal geographic locations that are determined by the stored associations between the geographic area and the category of the plurality of categories.

10. The method of claim 9, wherein the determining, using the one or more computing devices, the category of the plurality of categories associated with the largest number of the at least one of the plurality of geographic locations further comprises:
determining, using the one or more computing devices, whether the number of the at least one of the plurality of geographic locations that are associated with the category of the plurality of categories satisfies a threshold;
expanding, using the one or more computing devices, the geographic area to encompass additional geographic locations of the plurality of geographic locations based at least in part on the threshold not being satisfied; and
repeating, using the one or more computing devices, the determining and the expanding until the threshold is satisfied.

11. (canceled)

12. The method of claim 9, wherein the determining, using the one or more computing devices, the category of the plurality of categories associated with the largest number of the at least one of the plurality of geographic locations further comprises:
determining, using the one or more computing devices, the category of the plurality of categories associated with the largest number of the at least one of the plurality of geographic locations based at least in part on the plurality of weights associated with the plurality of categories.

13. The method of claim 9, wherein each of the plurality of outcomes is characterized as a positive outcome or a negative outcome, the weight of the plurality of weights determined with respect to the positive outcome having a positive value and the weight of the plurality of weights determined with respect to the negative outcome having a negative value.

14. The method of claim 13, wherein the determining, using the one or more computing devices, the category of the plurality of categories associated with the largest number of the at least one of the plurality of geographic locations further comprises:
determining, using the one or more computing devices, the category of the plurality of categories associated with the largest number of the at least one of the plurality of geographic locations based at least in part on the positive and negative values of the plurality of weights associated with the at least one of the plurality of geographic locations.

15. The method of claim 13, wherein at least one of the plurality of outcomes that is characterized as the negative outcome comprises at least one of an unsuccessful search or an indication of a negative user preference.

16. The method of claim 9, further comprising:
receiving, using the one or more computing devices, a request for an advertisement that comprises an indication of a geographic region that is located within the geographic area;
retrieving, using the one or more computing devices, the association between the category of the plurality of categories and the geographic area; and
retrieving, using the one or more computing devices, an advertisement based at least in part on the category of the plurality of categories.

17. A system, comprising:
one or more processors; and
a memory including instructions that, when executed by the one or more processors, cause the one or more processors to:
receive a plurality of geographic locations each having been associated with one of a plurality of categories based at least in part on a plurality of user interactions with a map service, wherein each of the plurality of geographic locations is further associated with one of a plurality of weights based at least in part on the plurality of user interactions and whether the user interactions resulted in a positive outcome associated with a successful search or a negative outcome associated with an unsuccessful search;
associate a geographic area that encompasses the plurality of geographic locations with a category of the plurality of categories that is associated with a largest number of the plurality of geographic locations;
determine clusters of proximal geographic locations that have a common category, wherein the determining clusters is based at least in part on the associations between each geographic area and its corresponding category;
receive an advertisement request that comprises an indication of one of the plurality of geographic locations that is encompassed by the geographic area; and
provide an advertisement that is selected based at least in part on the clusters of proximal geographic locations that are determined by the category of the plurality of categories associated with the geographic area that encompasses the one of the plurality of geographic locations.

18. (canceled)

19. The system of claim 17, wherein the memory further includes instructions that, when executed by the one or more processors, cause the one or more processors to:
associate the geographic area that encompasses the plurality of geographic locations with the category of the plurality of categories that is associated with the largest number of the plurality of geographic locations based at least in part on the plurality of weights associated with the plurality of geographic locations.

20. The system of claim 17, wherein the memory further includes instructions that, when executed by the one or more processors, cause the one or more processors to:
display the advertisement on a web page that comprises a map, wherein the advertisement is displayed non-overlapping with the map.

21. A non-transitory machine readable medium embodying instructions that, when executed by a machine, cause the machine to perform a method for providing advertisements based on categorizations of geographic areas, the method comprising:
determining a plurality of geographic locations associated with a plurality of categories based on a plurality of user interactions;
determining a plurality of geographic areas, each of the plurality of geographic areas encompassing at least two of the plurality of geographic locations, wherein each of the plurality of geographic locations is encompassed by one of the plurality of geographic areas;
determining a plurality of positive and negative outcomes based on the plurality of user interactions, wherein the positive outcomes are associated with successful searches and the negative outcomes are associated with unsuccessful searches, and wherein each of the plurality of outcomes is associated with one of the plurality of geographic locations;
determining a plurality of weights of the plurality of outcomes, wherein the plurality of weights indicate how strongly the plurality of outcomes are indicative of user intent;
determining with respect to each of the plurality of outcomes, one of a plurality of categories that relates to each of the plurality of outcomes;
associating each of the plurality of geographic areas with the category of the plurality of categories that is associated with a largest number of the at least two of the plurality of geographic locations encompassed by each of the plurality of geographic areas, respectively;
determining clusters of proximal geographic locations that have a common category, wherein the determining clusters is based at least in part on the associations between each geographic area and its corresponding category;
receiving an advertisement request that comprises an indication of a geographic region; and
providing an advertisement that is selected based at least in part on the clusters of proximal geographic locations that are determined by the category of the plurality of categories that is associated with the geographic area of the plurality of geographic areas that encompasses the geographic region.

22. The non-transitory machine readable medium of claim 21, wherein the method further comprises:
displaying the advertisement on a web page that comprises a map, wherein the advertisement is displayed on the web page non-overlapping with the map.
